(19) United States
(12) Patent Application Publication
(10) Pub. No.: US 2016/0117642 A1
(43) Pub. Date: Apr. 28, 2016

(54) Marketplace for Service Providers' Time

(71) Applicant: Haramol Singh Sandhu, McLean, VA (US)

(72) Inventor: Haramol Singh Sandhu, McLean, VA (US)

(21) Appl. No.: 14/871,946

(22) Filed: Sep. 30, 2015

Related U.S. Application Data
(60) Provisional application No. 62/067,344, filed on Oct. 22, 2014.
(60) Provisional application No. 62/143,089, filed on Apr. 4, 2015.
(60) Provisional application No. 62/149,595, filed on Apr. 18, 2015.

(51) Int. Cl. G06Q 10/10

(52) U.S. Cl. CPC G06Q 10/1053

(57) ABSTRACT

A computer implemented system and method whereby service providers offer blocks of their available time to be bid upon by service buyers. In addition, with respect to a time block for which service has been performed, fee and ratings data are used to derive a monetary value rating per unit of time for the time block. The monetary value rating with respect to a time block is aggregated and averaged with other such ratings received by the service provider on other time blocks to provide expected value information to the marketplace. This expected value per unit of time worked or billed would likely correlate to the actual fees that the service provider is able to command on the auction marketplace with respect to future time blocks.

### CROSS REFERENCE TO RELATED APPLICATIONS

This application claims priority under 35 U.S.C. §119(e) of the following three provisional patent applications: 1) U.S. Provisional Application 62/067,344, filed Oct. 22, 2014, the entire contents of which are hereby incorporated by reference; 2) U.S. Provisional Application 62/143,089, filed Apr. 4, 2015, the entire contents of which are hereby incorporated by reference; and 3) U.S. Provisional Application 62/149,595, filed Apr. 18, 2015, the entire contents of which are hereby incorporated by reference.

### FIELD OF THE INVENTION

The present invention relates to the online procurement of services. More specifically, the present invention relates to the hiring of service providers via the Internet or other network.

### BACKGROUND

There are a number of methods whereby potential buyers of services (sometimes referred to herein as consumers or service buyers) can be connected with service providers via the Internet. For example, search engines are sometimes used to help service buyers find service providers to provide the desired services. In addition, a number of websites specifically provide for listings of service providers/professionals (such as, for example, linkedin.com). Still other websites provide for projects and the matching of service buyers and service providers (such as, for example, guru.com and upwork.com), with many of these websites also providing for the rating of service provider performance upon project completion.

Some methods have been implemented to sort data and provide it in a more useful manner to users. U.S. Pat. No. 6,871,181 to Kansal teaches a method for assessing, scoring, ranking and rating technology vendors for the purpose of comparing vendor bids on a project. A score or ranking is developed for each of the vendors based upon the vendor's historical reliability as well as normalizing the vendor's ranking with respect to the other vendors for the purpose of determining the appropriate vendor. U.S. Patent App. No. 2006/0212359 to Hudgeon teaches ratings based on performance attributes such as service quality, timeliness and cost. In addition, sites such as Upwork, rentacoder.com and guru.com use ratings to provide a method to compare service providers. Rentacoder.com uses an equation which sums the cost of each job times the adjusted rating of each job minus each missed status report value. Guru.com ranks users by category and also based on feedback and money earned.

The traditional online service provider marketplace model (whereby service buyers post projects and service providers bid to work on the project) and existing service provider ranking and rating schemes have provided some efficiencies to the marketplace for services, particularly with respect to commoditized work and work for lower-skill level projects and jobs. In addition, some websites have tried other models in order to attempt to provide a better system of connecting service providers and consumers. For example, Jobpic, a now-defunct website, provided a marketplace for service providers to post a service that could be bid upon by potential consumers.

Nevertheless, the matching of service providers and consumers has remained largely inefficient. The delivery of services has some major differences with the delivery of goods. For example, measuring performance simply in terms of the delivery of the final product is well-suited for the delivery of goods. In addition, compared to the delivery of goods, the delivery of services is subject to greater variability (both in project scope and performance by the provider) and also subject to greater difficulty in measuring and comparing relative service provider performance (despite the more acute need to provide a more useful system for comparing provider performance for services compared to goods). Despite these and other differences inherent between the delivery of goods and services, to date the discrete project model and traditional ratings metrics used in goods marketplaces have largely been adopted with little change and used in services marketplaces.

### REFERENCES CITED

### U.S. Patent Documents Other than the Related Provisional Patent Applications

| | | |
|---|---|---|
| US 2007/0192130 | August 2007 | Sandhu |
| U.S. Pat. No. 8,380,709 B1 | February 2013 | Diller et. al. |
| U.S. Pat. No. 8,700,614 B1 | April 2014 | Diller et. al. |
| WO 2010018450 A2 | February 2010 | McCarney et. al. |
| U.S. Pat. No. 13/750,871 | August 2013 | Hindi et. al. |
| US 2013/0246301 A1 | September 2013 | Radhakrishnan et. al. |
| U.S. Pat. No. 7,895,061 B2 | February 2011 | Schoenberg |
| WO 2008030855 A1 | Match 2008 | Schoenberg and |
| | | Schoenberg |
| US 20150058171 A1 | February 2015 | Sandhu |

### SUMMARY

The system uses a unique approach to create a more efficient marketplace for services. Instead of pricing with respect to a project posted by a service buyer, the system uses blocks of time to standardize units of measurement across service providers and across projects. The system contemplates an auction marketplace whereby service providers offer blocks of their time to be bid upon by potential service buyers. In addition, it is contemplated that after service is performed for the block of time (or for a portion of the block of time), the service buyer provides a rating as to the service performed. Furthermore, it is contemplated that, in addition to traditional qualitative or quantitative ratings metrics (or in place of such metrics), the post-service rating is provided in the form of either a direct expression of the monetary value provided per unit of time worked or in the form of a rating that is used to adjust the actual fee data to produce a value rating per unit of time worked that, when averaged and otherwise aggregated with other such ratings, provides useful comparative information to the marketplace as to the expected value of the service provider's service per unit of time worked.

A dynamic market for services is contemplated whereby useful information as to the competency of service providers is available to potential service buyers based on the average/aggregate post-project performance valuation ratings data and average/aggregate pricing and other data. In addition to other advantages over existing services marketplaces, the system has the advantage of signaling to the marketplace the expected value per unit of time provided by a service provider, which it is contemplated would likely correlate to the actual fees that the service provider is able to command on the marketplace.

### BRIEF DESCRIPTION OF THE DRAWINGS

Non-limiting and non-exhaustive embodiments of the invention are described, in part, with reference to FIG. 1, which is an exemplary flow chart showing a portion of the steps taken with respect to a project/job using the system.

FIG. 2 illustrates an exemplary calendar of time slots and bids from the perspective of a service provider.

FIG. 3 illustrates an exemplary screen for a service buyer to bid on a service provider's time block.

FIG. 4 illustrates an exemplary screen for a service buyer to rate a service provider's performance on a completed time block.

### DETAILED DESCRIPTION

This document describes a system and method for a marketplace connecting service providers and service buyers. In addition, this document contemplates a dynamic market for professional services that results from the aggregation of the data described herein with respect to multiple blocks of time. In the following description, numerous specific details are set forth to provide a thorough understanding of the embodiments. One skilled in the relevant art will recognize, however, that the techniques described herein can be practiced without one or more of the specific details, or with other methods or details. In other instances, well-known operations are not shown or described in detail to avoid obscuring certain aspects. For example, details relating to networks, such as the Internet generally and more specifically common methods and processes used in websites connecting service buyers and service providers, details included in websites with profiles of service providers, search engine processes, and processes related to storing and accessing information in a database related to service providers, service buyers, and projects performed through a website are not described in detail herein.

Reference throughout this specification to “one embodiment” or similar terminology means that a particular feature, structure, or characteristic described in connection with the embodiment is included in at least one embodiment of the present invention. Thus, the appearances of the phrase “in one embodiment” or similar terminology in various places throughout this specification are not necessarily all referring to the same embodiment. Furthermore, particular features or characteristics described herein may be combined in any suitable manner in one or more embodiments.

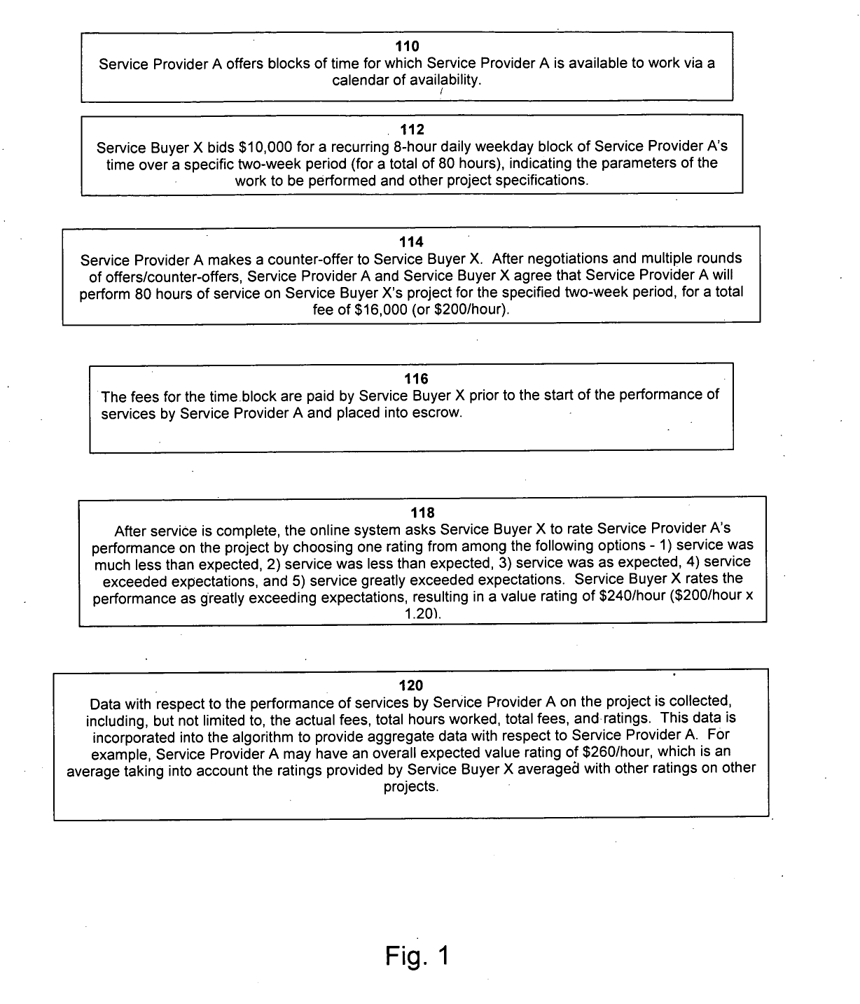

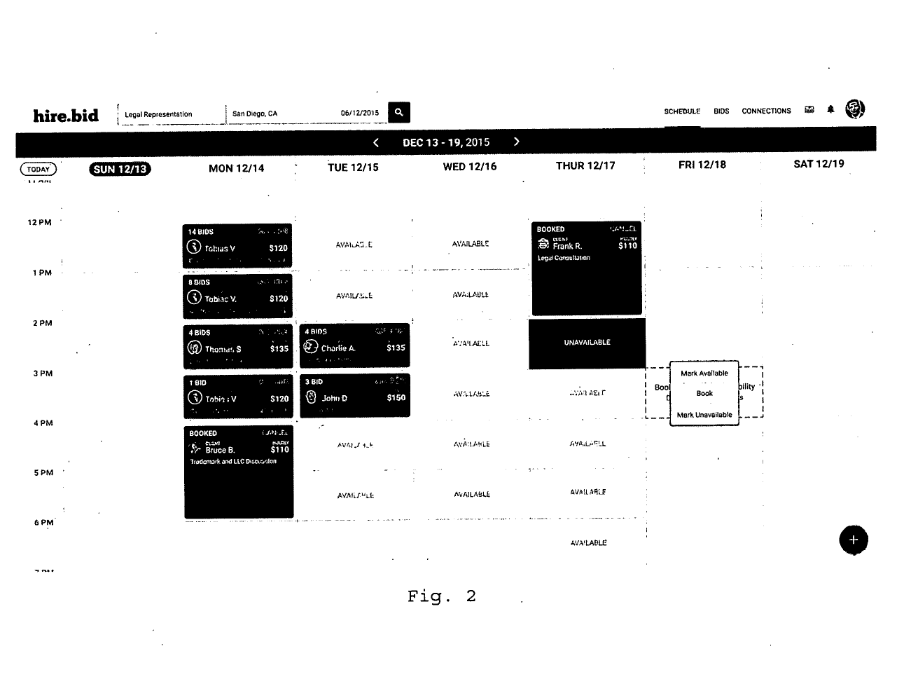

In one embodiment, a service provider (sometimes referred to herein as a professional, although this term is not meant to be restrictive) creates a professional profile on the marketplace. As exemplified by FIG. 2, in one embodiment, the service provider makes certain time blocks of the service provider's time available to be bid upon by consumers via a calendar of availability on the marketplace, potentially restricting bidding on certain time blocks for which the service provider is already booked and/or is not willing to work and/or specifying the blocks of time for which the service provider is willing to work 110. The blocks of time can either be discrete blocks of time over a specific time period (e.g., specific hours of specified days, weeks, months, or years) or an unspecified portion of a specific time period (e.g., 40 hours in January 2015). The service provider can set forth such parameters as minimum bids per unit of time (e.g., a minimum price per hour or minimum price for a 15-minute increment), with the minimums potentially varying (e.g., the minimum price could be different depending on the day and/or time of the day). In addition, other common auction methodologies could be utilized as adapted for the unique auction marketplace in one or more embodiments (such as the ability of a service provider to set minimum bids per unit of time, to set reserve prices, or to offer certain blocks of time at fixed prices).

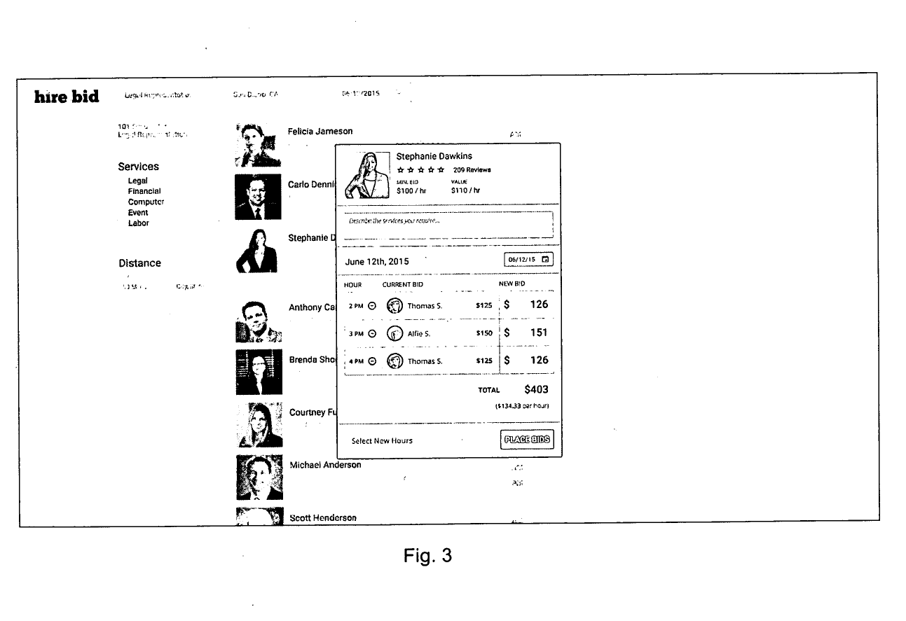

As exemplified by FIG. 3, in one embodiment, service buyers can bid for a service provider's time by setting out project details, specifying the dollar value of the bid (potentially with different hourly bids for different portions of the time block), and by specifying the block of time being bid upon (e.g., 9-11 AM on Sep. 3, 2016, or a recurring block over a period of days, weeks, or months). 112. It is contemplated that in one or more embodiments service providers can also express interest in particular projects being offered by service buyers. It is further contemplated that the bids made by a service buyer for different service providers or for different blocks of time for a project need not necessarily be uniform. Furthermore, it is contemplated that service providers could leave blocks of time open for a period to get competing bids, and can choose to accept, reject, or counter bids based on all information (e.g., project specifications, billing rate per hour worked, overall fee, any fee guarantees, total time allotted, etc.), and not just based on price. For example, the system could have a default that time blocks can be bid upon up until 24 hours in advance of the time block, and that bidders can bid on any available time block (or portion of such time block) in 15-minute or greater increments. Thus, for example, two different potential service buyers can bid on overlapping time blocks of the same professional such, as for example, one bid on a 11 AM-12 PM time block on a particular day, and a competing bid on a 11 AM-3 PM time block on that same day (potentially with, for example, a higher bid for the 11 AM-12 PM portion of the time block in order to outbid the competing bid on that portion of the time block) and the service provider can choose to accept one bid, the non-overlapping portions of one or more bids, and/or counter one or more of the bids to suggest a different non-overlapping time block. In addition, it is contemplated that the service provider could counter-offer by changing any of one or more time block details (e.g., counter at a higher rate, higher overall fee, with a change in project scope, and/or a different block of time, including a smaller or larger block of time or time on a different day, etc.) 114.

In the case of a discrete time block, it is contemplated that, if the service provider and service buyer agree to a block of time, that block of the service provider's time would be reserved in the system and unavailable for bids. In one embodiment, in the case of non-discrete time blocks, the system would have limits on total time that could be reserved over a given period, in order to prevent actual double-booking of time. In one embodiment, the system could use a methodology whereby a service buyer and service provider have the ability to agree to a small trial block of time with, for example, an option agreed to between the parties enabling the service buyer to be guaranteed the ability to purchase certain additional blocks of the service provider's time at a set price in order to continue to work on the project. It is also contemplated that a service buyer could reserve a block of time in excess of that which is contemplated to be needed to complete the project. In one embodiment, it is contemplated that if any block of time purchased was, in fact, not used (if, for example, the service provider completed the project without having to use the full block of time), then the unused portion would not be charged to the service buyer. In addition, in some embodiments, it is contemplated that the system could enable a service buyer to provide for a minimum guaranteed payment regardless of the total time used. Any unused portion of a block would become available for bidding for additional work by the same or other service buyers.

In one embodiment, it is contemplated that fees for the block of time or for a portion of a block of time (e.g., one week out of a longer block of time) would be placed in escrow 116 and then released to the service provider after the service for the block or portion of the block is performed (and the system could optionally provide that unused portions would be refunded back to the service buyer).

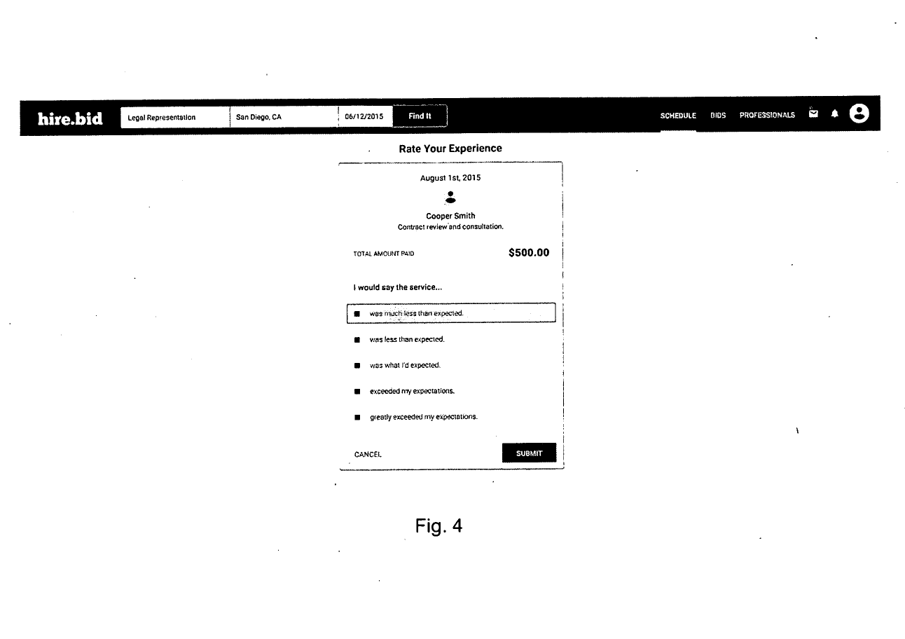

In some embodiments, in addition to (or in place of) traditional service provider ratings metrics, it is contemplated that the service buyer would provide qualitative feedback/ratings and/or quantitative ratings (such as ratings on a scale of 1-100) upon completion of the reserved block of time (or, if earlier, upon completion of the project) that would be used to adjust the actual hourly fee data with respect to that time block to produce a monetary value rating for that time block. For example, in one embodiment as exemplified by FIG. 4, the service buyer could select one rating from among the following options after a project: 1) service was much less than expected; 2) service was less than expected; 3) service was as expected; 4) service exceeded expectations; or 5) service greatly exceeded expectations. Then, in this embodiment, an adjustment factor to the actual hourly fee would be applied based on the ratings described in the previous sentence (e.g., −20% for service much less than expected, −10% for service less than expected, no adjustment for service as expected, +10% for service that exceeded expectations, and +20% for service that greatly exceeded expectations. 118. This adjustment would be applied to the actual hourly fee data with respect to that time block to provide a time block-specific value rating that would be averaged and otherwise aggregated with ratings from other time blocks by the service provider to produce an average that can be a useful measure of expected value provided by the service provider on future time blocks. 120. In some embodiments, the adjustment provided to produce the time block-specific value rating could be influenced by other factors, such as the accuracy and reliability of the service buyer in providing feedback to service providers with respect to other time blocks. Alternatively, rather than deriving a time-block specific value rating, in some embodiments, the system could directly ask the service buyer to provide a value rating as to the dollar value of the work provided per hour worked, regardless of the actual fees charged, and that this data would be aggregated with ratings from other time blocks to produce an average as to the expected value provided by the professional. Rather than providing ratings only upon completion of a time block, these methodologies could also be employed in one or more embodiments on a portion of a time block so that ratings are provided at a regular interval for a portion of a time block prior to completion of the entire time block (in the case of, for example, a larger time block that spans multiple weeks, months, or years).

It is contemplated that the ratings data and actual fee data with respect to a time block may be categorized according to project specifications or otherwise, so that average and aggregate service provider data could be available with respect to projects within a particular specialty/sub-specialty. In addition, it is also contemplated that the averaging algorithm could weight more recent blocks of time more in determining the average fee and/or ratings data, could weight larger blocks of time more in determining the weighted average, and/or could also take into account idle time so that average ratings/fee data may be lowered by taking into account the fact that time over a particular period was not worked on any projects through the system. In addition, it is contemplated that other adjustments may be applied to the ratings, to account for such things as past service buyer accuracy (as measured by correlation of past ratings provided by that service buyer and actual future fees commanded by the service providers that the service buyer has rated, or other methodologies) or, for example, to not take into account outlier ratings.

In addition to information customarily available on websites and/or provided in resumes/CVs with respect to a service provider's skills and expertise, one or more embodiments could include service provider profile pages that include some or all of the average/aggregate ratings data generated from the system. This data could also be subcategorized based on particular job/project classifications and average ratings could be determined algorithmically, whereby certain fees and ratings are given more or less weight due to various factors in determining the average rating for the service provider. For example, the weight a rating is given in determining the applicable average for the service provider (including project sub-category averages) could depend on the overall pay of a block of time, the length of the block of time, the time elapsed since service was performed for the block of time, and/or other factors with respect to the project or block of time. It is further contemplated that a service provider could have multiple profiles and/or sub-profiles such as, for example, if such service provider performs work for projects in more than one category/sub-category, blocks of time for projects within that category/sub-category will be used to determine average/aggregate sub-category data.

In some embodiments, it is contemplated that some or all of service provider profile information, such as some or all of the average ratings data applicable to a service provider, will be broadly accessible to individuals who access the website, while other information will only be accessible to the service buyer/project creator (such as project-specific information and ratings) and other information will only be accessible to the service provider. Similarly, it is contemplated that some or all the project information will be broadly accessible to individuals who access the website, while other information will only be accessible to the service buyer and/or service providers working on a project. Alternatively, some or all of the average fee/ratings data may only be accessible to certain individuals such as, for example, individuals or entities that have paid a fee to access such data. In other embodiments, most, if not all, of the ratings (including average ratings) may not be directly accessible to any users of the website and may instead, for example, be used to order or rank service providers and/or to suggest service providers for projects or otherwise match service providers and service buyers.

It is also contemplated that service providers who have high average ratings in categories/sub-categories matching a desired service provider search may show up higher in service provider search results on the system (and other factors can also influence service provider search result ordering, such as, for example, the number of projects performed by the service provider for which there is data, how close the service provider's expertise or work on past projects matches the search, etc.).

It is also contemplated that the system may also combine some elements of a more traditional service buyer/service provider marketplace with the system and method herein so that, for example, service buyers can post projects on the marketplace. In addition, it is contemplated that, based on information with respect to past time blocks worked, the algorithm may automatically suggest service providers for a project to the project creator and/or otherwise flag service providers that appear to be a good match for a project at the time of project creation, taking into account all relevant data, including past time block and project data (including similarities in scope and expertise required in the current project as compared to other past projects and/or comparison of highly-rated service providers for similar past projects as well as, for example, an applicable average value rating that equals or exceeds the applicable project fees). Similarly, in one embodiment, it is contemplated that the system will automatically suggest projects to service providers, so that these service providers can express interest in working on these projects, taking into account service provider and project data (including past project history of the service provider, such as similarities in scope and expertise of the open projects compared to past projects for which the service provider worked time blocks).

The present invention has been described in terms of specific embodiments incorporating details to facilitate the understanding of principles of construction and operation of the invention. The description herein is not intended to be exhaustive or to limit the invention to the precise forms disclosed. Variations to specific embodiments and details are encompassed by this disclosure. Thus, for example, even though service buyers and service providers are generally described as individuals herein, it is contemplated that each can instead be groups of individuals or entities. Similarly, even though the invention is generally described as applying to discrete projects herein, it is contemplated that this invention can also apply to longer-term jobs or groups of projects. It is intended that the scope of the invention is defined by the claims and their equivalents. Furthermore, it is contemplated that a particular feature described either individually or as part of an embodiment, can be combined with other individually described features, or parts of other embodiments. Thus, absence of describing combinations should not preclude the inventor from claiming rights to such combinations. Various modifications to the disclosed embodiments will be readily apparent to those skilled in the art, and the general principles defined herein may be applied to other embodiments and applications without departing from the spirit and scope of the present embodiments. Thus, the system is not limited to the embodiments shown, but is to be accorded the widest scope consistent with the principles and features disclosed herein.

The invention claimed is:

1. A computer implemented method for an online auction marketplace whereby service providers offer blocks of their time to be bid upon by potential service buyers.

2. The computer implemented method of claim 1; further comprising a system and method whereby a service buyer can bid to reserve a block of the service provider's time by providing the project specifications and monetary bid for that time block.

3. The computer implemented method of claim 1; further comprising a system and method whereby different monetary bids can be made for a portion of a time block and a service buyer's bid can be accepted, rejected, or counter-offered by the service provider.

4. The computer implemented method of claim 1, further comprising a system and method for accessing service providers' calendars to view available time and to bid upon that time.

5. The computer implemented method of claim 1, further comprising a system and method of providing ratings by the service buyer as to the performance of the service provider upon completion of a time block (or a portion of a time block).

6. The computer implemented method of claim 5, wherein the ratings provided are an opinion by the service buyer of the monetary value provided per unit of time worked or billed by the service provider (regardless of actual fee charged).

7. The computer implemented method of claim 5, further comprising a system and method of using the ratings provided by the service buyer to adjust the actual fees paid per unit of time worked or billed in order to calculate a monetary value rating of the service provided on the time block (or portion of the time block).

8. The computer implemented method of claim 5, further comprising a system and method of averaging and aggregating such ratings given to a service provider on multiple time blocks on work for that service buyer and other service buyers.

9. The computer implemented method of claim 6, further comprising a system and method of averaging and aggregating such ratings given to a service provider on multiple time blocks on work for that service buyer and other service buyers.

10. The computer implemented method of claim 7, further comprising a system and method of averaging and aggregating such ratings given to a service provider on multiple time blocks on work for that service buyer and other service buyers.

11. The computer implemented method of claim 8, further comprising a system and method of calculating sub-category average ratings for a service provider with respect to time blocks within a certain sub-category or type of project (according to the project specifications or expertise required).

12. The computer implemented method of claim 9, further comprising a system and method of calculating sub-category average ratings for a service provider with respect to time blocks within a certain sub-category or type of project (according to the project specifications or expertise required).

13. The computer implemented method of claim 10, further comprising a system and method of calculating sub-category average ratings for a service provider with respect to time blocks within a certain sub-category or type of project (according to the project specifications or expertise required).

14. A computer implemented method for purchasing services in units of time and for rating the level of service provided per unit of time based on the monetary value provided.

15. The computer implemented method of claim 14, wherein the purchasing of services takes place via an auction marketplace that provides a system for service buyers to bid upon service providers' time.

16. The computer implemented method of claim 14, wherein the ratings provided are an opinion by the service buyer after services are performed for the units of time purchased (or for a portion of the units of time purchased) of the monetary value provided per unit of time worked or billed by the service provider (regardless of actual fee charged).

17. The computer implemented method of claim 14, wherein qualitative feedback is used to adjust the actual fees paid per unit of time worked or billed in order to calculate the monetary value rating.

18. The computer implemented method of claim 14, wherein ratings provided on a quantitative scale are used to adjust the actual fees paid per unit of time worked or billed in order to calculate the monetary value rating.

19. The computer implemented method of claim 14, further comprising a system and method of averaging and aggregating such ratings given to a service provider on multiple time blocks on work for that service buyer and other service buyers.

20. The computer implemented method of claim 19, further comprising a system and method of calculating sub-category average ratings for a service provider with respect to time blocks within a certain sub-category or type of project (according to the project specifications or expertise required).
